(19) United States
(12) Patent Application Publication
(10) Pub. No.: US 2003/0009254 A1
(43) Pub. Date: Jan. 9, 2003

(54) Method for tracking identity traits of commodities

(76) Inventors: Steven J. Carlson, Kasson, MN (US); Kevin A. Born, Janesville, MN (US); John D. Ahlberg, Owatonna, MN (US); C. Thomas Gray, Owatonna, MN (US)

Correspondence Address: PATENT DEPARTMENT, LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 10/192,247

(22) Filed: Jul. 9, 2002

Related U.S. Application Data
(60) Provisional application No. 60/303,954, filed on Jul. 9, 2001.

(51) Int. Cl. G06F 7/00; G06F 19/00

(52) U.S. Cl. 700/115; 700/219; 700/229

(57) ABSTRACT

The present invention is a method for tracking identity traits of commodities during the production, handling, processing and/or distribution chain of the commodity. The method includes providing a database having a unique identifier identifying a commodity to be tracked, inputting identity traits of the commodity into the database, associating the inputted identity traits with the unique identifier, tagging the commodity with a tag associated with the unique identifier, and selectively retrieving from the database the preserved identity traits of the commodity by querying the database.

### CROSS-REFERENCE TO RELATED APPLICATIONS

This is a non-provisional patent application based on co-pending U.S. provisional application No. 60/303,954 entitled “System for Tracking Identity-Preserved Traits Through the Production and Processing Chain,” filed Jul. 09, 2001, the disclosure of which is incorporated herein by reference. Priority is claimed thereto pursuant to 35 U.S.C. §119(e).

### BACKGROUND OF THE INVENTION

1. Field of the Invention

The present invention relates to a method for tracking identity traits of commodities and more particularly to a method of tracking identity traits of commodities using a networked database.

2. Description of the Related Art

Processors of certain commodities have long been engaged in tracking and certifying commodities used in or comprising their products. For example, many grain processors such as brewers, breakfast cereal producers, baking companies, and grain ethanol producers, etc. contract with farmers to produce grain used in their products. The grain typically is certified by the processor to ensure it meets the processors specified requirements. Under these contracts, the processors typically supply certified seed with the desired hybrid characteristics to the farmer. The farmer is also typically required to maintain records as to where the certified seed was planted, the types of fertilizers, herbicides, pesticides, etc., applied during the growing season (if any), harvesting information, and any other desired information. The processor may also require those handling the certified grain, such as storage facilities, shipping companies, etc. to provide handling information concerning the grain until it is delivered to the processor. When applicable the producer may also be required to provide handling information. The processor often inspect the farmer's operations at various stages of the planting, production, harvesting and if applicable, storage and/or transportation of the grain to certify that the farmer is in compliance with the processor's specified guidelines. If the farmer complies with the processor's requirements and the harvested crop is certified by the food processor, the farmer is able to sell the harvested grain back to the food processor typically at a premium price. If the harvested crop is not certified due to the farmer's failure to comply with the processor's guidelines or if the characteristics of the harvested crop do not comply with the processor's specifications, the farmer must sell his crop on the open market. The processor may also inspect the grain handler's operations to certify that the handler is in compliance with the processors specified handling guidelines.

Accordingly, there is a need for commodity producers, processors, handlers, distributors and other interested parties to be able to easily record the various attributes during the production, handling and processing chain such that the events and attributes associated with each of these steps along the chain can be accurately preserved. There is also a need to ensure that the preserved attributes are properly associated with the commodity such that the commodity can be accurately tracked throughout the various stages of the chain.

In addition to the foregoing example, certain markets, including the European Union and Japan, require labeling of food products that contain “genetically modified organisms” (GMO). One well know example of such a GMO is Roundup Ready® corn or soybeans developed to be resistant to the popular Roundup® herbicide manufactured by Monsanto Company. Various methods have been devised to enable persons in the distribution of agricultural commodities to be able to identify those commodities that are considered GMO or GMO-free. U.S. Pat. No. 6,406,725 issued to Taylor discloses one such method of visually labeling GMO grain with inert, colored pellets or “taggants.” By practicing the Taylor '725 method, any grain containing these colored taggants would be readily identifiable as being GMO grain such that it may be segregated from GMO-free grain as necessary. While Taylor '725 is useful for its intended purpose, interested parties may not be able to determine when, where or by whom the grain was tagged as GMO grain or, for that matter, whether it is properly tagged as containing GMO.

Accordingly, there is a need for not only allowing commodities to be readily identifiable based on certain predefined identity traits, but there is a need for a method of being able to accurately and reliably identify the identity traits of commodities throughout the production, handling, processing, and distribution chains so that parties wishing to ensure themselves of the identity traits of a commodity at any stage along the chain have a readily accessible, accurate and complete history of the desired identity traits for that commodity.

As identified above, the parties who would benefit from having ready access to identity traits of a commodity include those responsible for producing, handling, processing and distributing the processed commodity. In addition, to the foregoing, individual consumers would also benefit from being able to track the identity traits of the processed commodity, particularly those that may have food allergies resulting from certain chemicals or additives that may be used in processing the commodity, or those who subscribe to religious or ethnic eating habits, or those consumers who want to know whether a specific foodstuff is subject to recall or potential contamination, or to those consumers who simply prefer to have as much knowledge as possible about the commodities they use or consume.

### SUMMARY OF THE INVENTION

The present invention is a method for tracking identity traits of commodities preferably throughout the entire production, handling, processing and distribution chain of the commodity. The method includes providing a database having a unique identifier identifying a commodity to be tracked, inputting identity traits of the commodity into the database, associating the inputted identity traits with the unique identifier, tagging the commodity with a tag associated with the unique identifier, and selectively retrieving from the database the preserved identity traits of the commodity by querying the database using the unique database identifier or any other data element input.

In the preferred embodiment, the database resides on a network accessible computer server which can be accessed remotely by interested parties. Preferably the step of inputting the identity traits of the commodity is performed remotely by authorized users throughout each stage of the production, handling, processing and distribution chain upon the occurrence of an event constituting an identity trait desired to be tracked. In the preferred embodiment, the identity traits include starting attributes, production attributes, handling attributes, processing attributes and distribution attributes of the commodity.

Preferably, the tag includes a computer-readable medium encoded with the commodity's unique identifier such that the step of selectively retrieving the commodity's preserved identity traits is performed automatically using a computing device adapted to read the unique identifier encoded in the tag's computer-readable medium and adapted to communicate with the database to execute a remote query to receive said tagged commodity's preserved identity traits.

### BRIEF DESCRIPTION OF THE SEVERAL VIEWS OF THE DRAWINGS

FIGS. 1 and 2 are schematic illustrations of the method of the present invention.

### DETAILED DESCRIPTION OF THE INVENTION

The present invention is a method for tracking preserved identity traits of a commodity, preferably throughout the entire chain of production, handling, processing and distribution of the commodity. As used in the present invention, the term “commodity” refers to any type of raw material or product that may be used by individual or industry consumers or processed into other products for human or animal consumption or use in industry. Thus, although reference is made in the description of the preferred embodiments to examples wherein the commodities are agricultural commodities it should be understood that the present invention applies equally to any commodities as identified above.

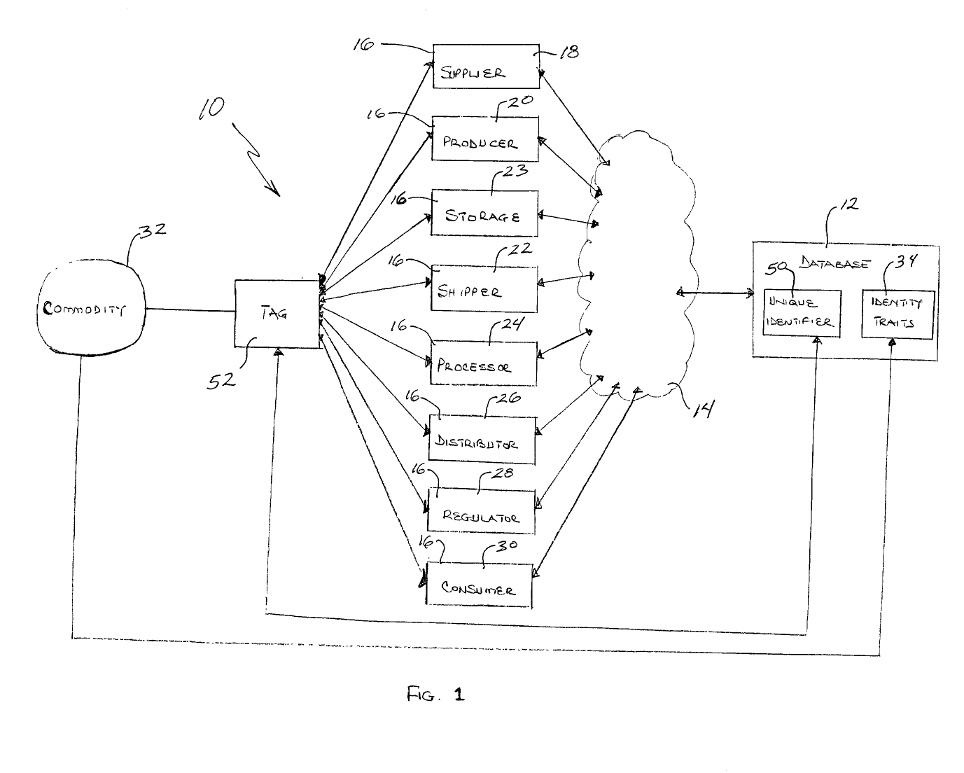

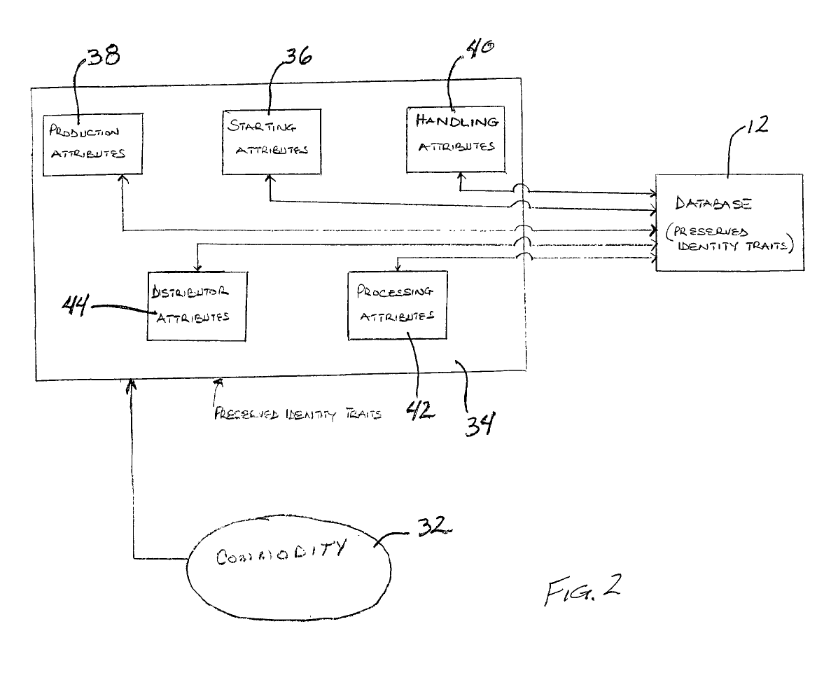

Referring to FIG. 1, the present invention 10 comprises a database 12 preferably accessible over a network 14, such as the Internet, an intranet, an extranet or any other type of wired or wireless data exchange network, by authorized users 16, which may include raw material suppliers 18, producers 20, shippers 22, storage providers 23, processors 24, distributors 26, regulators 28 and consumers 30 of the commodity 32. Each authorized user 16 preferably accesses the database 12 to input identity traits 34 (FIG. 2) of the commodity 32 desired to be tracked. Preferably the step of inputting the identity traits 34 of the commodity 32 is performed remotely by authorized users 16 throughout each stage of the production, handling, processing and distribution of the commodity upon the occurrence of an event constituting an identity trait desired to be tracked. As shown in FIG. 2, in the preferred embodiment, the identity traits 34 include starting attributes 36, production attributes 38, handling attributes 40, processing attributes 42 and distribution attributes 44 of the commodity 32. It should be understood, however, depending on the commodity to be tracked and the desired identity traits to be tracked, some of the above identified attributes may not be applicable or other attributes may be desired. Thus, the present invention should not be construed as being limited to the identity traits identified herein.

In the database, the commodity 32 to be tracked is given a unique database identifier 50 which is used to associate the inputted identity traits 34 with that particular commodity 32. In order to maintain control over the identity of the commodity 32 during handling operations, which may include multiple storage facilities and multiple forms of transportation, the commodity is tagged with a tag 52 associated with the unique database identifier 50. The unique database identifier 50 may be printed on the tag 52 and may include a machine-readable medium encoded with the unique database identifier 50. Depending on the commodity being tracked the tag 52 may be a taggant, label, stamp, or even a document (for example a certificate of authenticity) accompanying the commodity. The term “taggant” as used herein may include confetti (i.e., strips of paper or other material with either information printed thereon, or possibly color coded) mixed into the commodity such as grain. The term “taggant” may also include various color coded dyes, or color coded pellets such as disclosed in U.S. Pat. No. 6,406,725, which is incorporated herein by reference, or any other type of additive for visually or electronically identifying a commodity. In the preferred embodiment, the tag 52 preferably includes a machine-readable medium, such as a bar code, magnetic strip, or the like, encoded with the unique database identifier 50. Thus, during handling of the commodity 32, users 16 of the present invention may utilize computing devices, such as handheld or stationary scanners, or the like, to obtain the unique identifier from the tag 52, thus minimizing inaccuracies and errors due to transposing numbers or letters comprising the unique database identifier 50 of the commodity.

Once the unique identifier 50 is obtained from the tag 52, the user 16 may query the database 12 to selectively retrieve the commodity's identity traits 34 associated with the unique identifier 50. In the preferred embodiment, the step of retrieving the identity traits from the database 12 is performed automatically by the preferred computing device which executes a database query over the network 14 based on the unique identifier 50 obtained by scanning the tag 52. In an alternative embodiment, the tag 52 may simply list the identity traits 34 of the commodity 32 for visual inspection by a user 16 or alternatively, the identity traits 34 may be encoded on the tag 52 for retrieval and display by the remote computing device. In any event, once the user obtains the identity traits 34 of the commodity 32 being tracked, the user is able to view the preserved identity traits 34 from the database 12 to use this information to verify that the subject commodity is indeed the commodity in question, as well as to view the preserved identity traits of the subject commodity which may be necessary for purposes of accepting or rejecting the commodity at some point along the chain, certifying the commodity or inspecting the commodity, etc. as the case may be.

The following examples are provided for purposes of clarity and understanding of the present invention.

### EXAMPLE 1

Assume the commodity 32 to be tracked is a quantity of wheat to be produced by a farmer 20 under contract with a mill 24 for making flour. The mill 24 provides the farmer 20 with a special seed hybrid that has been certified to meet the mill's specified guidelines. Under the mills guidelines, the farmer 20 is permitted to use only pre-approved fertilizers, herbicides and pesticides that can be applied no later than twelve weeks before harvesting the grain. Furthermore, the mill's guidelines specify that the moisture content of the wheat can be no greater than ten percent at the time of harvest and that the harvested grain cannot be mixed with any other grain. Thus all storage and transportation facilities used by the farmer and all subsequent handlers of the harvested grain must ensure that their storage bins, wagons, grain carts, trailers, augers, elevators, dryers, etc. are thoroughly cleaned and do not contain any other grain.

An authorized employee of the mill 24 accesses the database 12 to provide a unique database identifier 50 for the wheat 32 to be produced by the farmer 20. The mill employee also updates the database 12 by inputting the initial identity traits 34 to be tracked for the contracted wheat 32, which includes various starting attributes 36, such as the type of seed to be supplied to the farmer, traced by lot number, plant origination, production field, research results, and the like. The shipper 22 responsible for transporting and delivering the certified seed to the farmer may be given access to the database 12 to further input other desired starting attributes 36 such as delivery schedules, routes, date of acceptance of the delivery, etc. using the unique database identifier 50 assigned to the commodity 32.

Once the certified seed 32 is delivered, the mill 24 gives the farmer access to the database 12. Using the unique identifier for the commodity, the farmer inputs relevant production attributes 38 for the wheat crop during the course of the growing season. Relevant production attributes 38 may include field identification, tillage practices, date of application of fertilizers, fertilizer type and application rates, dates of planting, seed population, dates of application of herbicides and pesticides, type of herbicides and pesticides applied, application rates, irrigation schedules and rates, weather conditions, harvesting dates, yield, moisture content of the harvested grain, etc.

At any time during the growing season an inspector from the mill may inspect the crop, as well as audit the farmer's tillage, planting, harvesting and storage practices, etc. The inspector may update the database 12 confirming or commenting on the farmers practices, provide recommendations, and indicating whether the crop meets the certification requirements for delivery to the mill. At this time, the inspector may tag harvested grain with a tag as described above.

Any parties responsible for handling the tagged grain, whether by the farmer, a storage facility or shipping company, may be authorized to access the database using the unique identifier for the commodity to update the database as to the handling attributes 40 to be recorded. Handling attributes may include pickup and delivery schedules, routes, vehicle or storage information, etc.

Once the commodity is delivered to the mill, authorized personnel may update the database by inputting processing attributes 42 performed on the tagged commodity, including various processing steps, additives, etc. The end product comprising the tagged commodity may also be tagged with an identical tag or a different tag associated with the unique database identifier of the subject commodity. Similarly, any parties involved in the distribution of the tagged end product comprising the commodity may be provided access to the database for inputting distributor attributes in association with the unique identifier, including pickup and delivery schedules, routes, vehicle or storage information, delivery sites, etc.

Finally, end consumers, wholesalers, retailers and other interested parties may be granted read only access and/or read-write access to the database to view the identity traits of the tagged product. In addition, the wholesalers and retailers, for example, may input the number of tagged products sold, tagged products in inventory, etc. thereby enabling the mill and/or distributor to monitor manufacturing and delivery schedules for additional tagged products.

### EXAMPLE 2

Consider the same set of assumptions as in Example 1, but further assume the producer or handling company inadvertently mixed the grain with GMO grain. Thus, the crop was not certified by the mill, thereby forcing the producer to sell the GMO grain on the open market.

Under this set of assumptions, the preserved identity traits would preferably include the information identifying when, where and how the grain was inadvertently mixed with the GMO grain. The tagged grain could thereafter be tracked or monitored by authorized users 16 of the present invention to ensure that the GMO grain is kept segregated as necessary from GMO-free grain during all handling procedures and any end-use products made from the GMO grain could be labeled as such

It should therefore be appreciated that in the event that the commodity is subject to an audit or an inquiry as to the quality of same, or with regard to a suspected contaminant, or in the event that the commodity or any input thereto is later detected to contain a contaminant, the present invention greatly increases the ability of authorized users to confirm the origination, treatment and handling of the commodity. The system of the present invention also provides an enhanced ability to quarantine or otherwise segregate the commodities containing contaminants or other undesired identity traits.

The present invention optionally provides “best practices” information so that any particular participant in the production, processing and distribution chain may benefit from industry-specific practices and provide certification of such best practices downstream to other participants. These best practices also provide tools that are usable for training and educating use of the present invention, if required.

Further, the type of information that may be used by, input, or accessible to a user of the present invention include, without limitation: product manuals; material safety data sheets; manufacturers' product sheets; photographic and other depictions of the commodity at various stages along the chain; contact information for all participants in producing, handling and processing said commodities; delivery schedules, dates, routes, locations and vehicle data for all delivery and shipping of the commodity; inventory data; and the like. These, and other pertinent information may be configured to any given data format for display, inspection, and/or printed out for signature or certification as to authenticity and accuracy. Such data may be audited by a software application producing dynamically generated responses to queries from any input in the production, handling, processing or distribution chain based on select data regarding any specific input, entity (or participant) or by final product, or any other related requirement or search request for relevant data related thereto.

In addition, certain data related to a proposed processing sequence, sale or transport of a commodity (raw material or final products) may occur in advance of such an event so that a user of the present invention may confirm the desirability of producing a final product using the commodity to be delivered pursuant to a pending order or other transaction. Thus, the total cost, unit cost, and the like, so that the economic benefit or the pending order or other transaction for any given product may be estimated or compared in aggregate to other similar given product, and the entity placing such an order for the product may be able to reconfigure the pending order or other transaction to accommodate a different or other commodity or otherwise meet specific unique requests by end users or other customers for such given product.

Some of the components and functions of the present invention include, without limitation, (i) providing accurate information to interested users regarding production input for final products through computerized means; (ii) incorporating production-related information traditionally included in paper-bound or hard copy reference books, manuals and information sheets into a centralized, searchable database structure for reference by diverse entities, including suppliers, producers, handlers, processors, distributors, consumers, inspectors, regulators, etc.; (iii) providing an interactive system which allows persons to enter real-time data into the system and provide a proposed product and/or services response to the consumer or company; (iv) providing a method of establishing “best practices” information for training and education of users of the present invention.

The present invention may further be comprised of a modular system each module of which includes topics such as product information; research information; pricing and price lists; historical data by customer; and a financial spreadsheet analysis for computation of customer production input planning needs and budgeted costs for various mixes of product and service. The system of the present invention is preferably downloadable to local computer (e.g., laptop, handheld or other computer now known or later devised) and/or may be made available over a computer network.

Additionally, the final product comprising the commodity may be provided with a certification label and/or a machine readable indicia that provides the consumer with a certificate of authenticity (or similar) as a further distinguishing feature of the final product. Furthermore, in lieu of, or in addition to the above label or indicia, a final product may be provided with a website address or other address or phone number so that a consumer (and/or intermediate producer) may visit the website address or other address or phone number and review the history of such identity-preserved traits of all raw materials and all (or any portion) of the details of the production of the final product. Given the recent advent of machine readable indicia, including kitchen and food preparation utensils and appliances, a label may contain a link (of the identity-preserved trait) to the information about a final product so that the link or the information itself may be read by a suitable so-called machine vision utility which may then create recipes using the final product, and the like.

Furthermore, it should be understood that the methods of the present invention may be (i) fully performed on a single computer workstation shared by a two parties who both have a role in the production of a given final (or intermediate) product; (ii) partially performed on a single computer shared by a first producer and a second producer; (iii) performed on several computers coupled together as a network (including the internet); (iv) performed manually in part and in part performed by computer; (v) performed on various nodes of a computer network; (vi) performed at different times by different, or common, computers with any interim results stored in computer memory available to either or both of said first producer and a second (or other) producer (or only to the first producer); (vii) performed initially by one or more of the above procedures and later amended or modified using any one or more of the above procedures; and, (viii) performed in whole or in part by one or more of a plurality of producers each having individual roles and associated equipment and each performing all or a portion of the production of a final (or intermediate) product.

Likewise, the present invention may be carried out entirely or in part using wireless data exchange networks, wired data exchange networks and further including all other data exchange networks now known and later devised. In addition, the present invention may utilize trained neural networks, expert systems, knowledge repositories, and may create and/or access historical database information automatically and/or create and access so-called frequently asked question databases in providing relevant information and guidance to assist a producer in disseminating the needs of the producer vis-a-vis a final (or intermediate) product.

Additional advantages and modifications will readily occur to those skilled in the art upon reflection on the teaching, written disclosure and illustrations herein. The invention in its broader aspects is, therefore, not limited to the specific details, representative apparatus and illustrative examples shown and described. Accordingly, departures from such details may be made without departing from the spirit or scope of the applicant's general inventive concept.

We claim:

1. A method of tracking preserved identity traits of commodity, said method comprising:
providing a database having a unique database identifier identifying a commodity to be tracked;
inputting identity traits of said commodity into said database;
associating said inputted identity traits with said unique database identifier, thereby preserving said identity traits with said commodity's unique database identifier;
tagging said commodity with a tag associated with said unique database identifier;
selectively retrieving from said database said preserved identity traits of said commodity by querying said database.

2. The method of claim 1 wherein said database is a networked database residing on a network accessible computer server.

3. The method of claim 2 wherein said step of inputting identity traits of said commodity is performed remotely via a computing device accessing said networked database.

4. The method of claim 3 wherein said tag includes a computer-readable medium encoded with said unique database identifier.

5. The method of claim 4 wherein said tag includes a computer-readable medium encoded with said preserved identity traits.

6. The method of claim 4 wherein the step of selectively retrieving from said database said preserved identity traits of said commodity by querying said database using said unique database identifier is performed is performed automatically using a computing device adapted to read said unique database identifier encoded in the tag's computer-readable medium and adapted to communicate over said network with said database to execute a remote query to receive and display the tagged commodity's preserved identity traits.

7. The method of claim 3 wherein said identity traits include starting attributes.

8. The method of claim 3 wherein said identity traits include production attributes.

9. The method of claim 3 wherein said identity traits include handling attributes.

10. The method of claim 3 wherein said identity traits include processing attributes.

11. The method of claim 3 wherein said identity traits include distribution attributes.
